(19) United States
(12) Patent Application Publication
(10) Pub. No.: US 2013/0151544 A1
(43) Pub. Date: Jun. 13, 2013

(54) INFORMATION PROCESSING APPARATUS, INFORMATION PROCESSING METHOD, AND PROGAM

(71) Applicants: Yuji Ishimura, Tokyo (JP); Masaki Yoshimura, Kanagawa (JP); Masaki Ito, Saitama (JP); Toshihiko Matsumoto, Tokyo (JP); Takahiro Chiba, Kanagawa (JP)

(72) Inventors: Yuji Ishimura, Tokyo (JP); Masaki Yoshimura, Kanagawa (JP); Masaki Ito, Saitama (JP); Toshihiko Matsumoto, Tokyo (JP); Takahiro Chiba, Kanagawa (JP)

(73) Assignee: SONY CORPORATION, Tokyo (JP)

(21) Appl. No.: 13/818,327

(22) PCT Filed: Aug. 24, 2011
(86) PCT No.: PCT/JP2011/004696

§ 371 Date: Feb. 22, 2013

(30) Foreign Application Priority Data
Sep. 2, 2010 (JP) 2010-196312

(51) Int. Cl. G06F 17/30

(52) U.S. Cl. CPC G06F 17/30477
USPC 707/758

(57) ABSTRACT

An apparatus for processing content data may include a memory. The apparatus may also include a buffer controller, which may be configured to overwrite recorded content data stored in the memory with new content data. The buffer controller may also be configured to receive a command signal indicative of a search request. Additionally, the buffer controller may be configured to, in response to the command signal, stop the overwriting. In addition, the apparatus may include a result display unit, which may be configured to generate a display signal to cause display of information regarding content represented by at least a portion of the recorded content data.

### TECHNICAL FIELD

The present disclosure relates to an information processing apparatus, an information processing method, and a program. More particularly, the present disclosure relates to an information processing apparatus, an information processing method, and a program configured to be able to more reliably search for information on a song played while content is viewed.

### BACKGROUND ART

In cases where a song of interest is played as BGM while a television program is viewed, ordinarily the user is required to use a personal computer to conduct a search with the commercial name, etc. as a search key and check song information. Such operations are cumbersome, and if the user does not conduct a search immediately after becoming interested, he or she may forget the commercial in which the song was being played.

### CITATION LIST

### Patent Literature

PTL 1: Japanese Unexamined Patent Application Publication No. 2010-166123

### SUMMARY OF INVENTION

### Technical Problem

It is conceivable to equip a TV with audio recording functions and functions for searching for information regarding a song based on recorded audio data. Thus, in the case where a song of interest is played as BGM, the user operates a remote control, etc. to order the TV to initiate recording, making it possible to conduct a search for information regarding a song based on recorded audio data.

However, finding the remote control takes time and effort, for example, and sometimes it may not be possible to initiate audio recording before the song of interest ends.

Accordingly, it is also conceivable to configure it such that audio data of television programs is constantly recorded, and recorded audio data is used to conduct a search when ordered by the user. Obviously, however, this becomes a problem of how much memory needs to be reserved as memory used to constantly record audio data. Also, this becomes a problem of when to delete audio data stored in memory.

The disclosed embodiments of the present invention, being devised in light of such circumstances, are configured to be able to more reliably search for information on a song played while content is viewed.

### Solution to Problem

There is disclosed an apparatus for processing content data. The apparatus may include a memory. The apparatus may also include a buffer controller, which may be configured to overwrite recorded content data stored in the memory with new content data. The buffer controller may also be configured to receive a command signal indicative of a search request. Additionally, the buffer controller may be configured to, in response to the command signal, stop the overwriting. In addition, the apparatus may include a result display unit, which may be configured to generate a display signal to cause display of information regarding content represented by at least a portion of the recorded content data.

There is also disclosed a method of processing content data. A processor may execute a program to cause an apparatus to perform the method. The program may be stored on a non-transitory, computer-readable storage medium. The method may include overwriting recorded content data stored in a memory with new content data. The method may also include receiving a command signal indicative of a search request. In addition, the method may include, in response to the command signal, (i) stopping the overwriting, and (ii) generating a display signal to cause display of information regarding content represented by at least a portion of the recorded content data.

According to the disclosed embodiments of the present invention, it is possible to more reliably search for information on a song played while content is viewed.

### BRIEF DESCRIPTION OF DRAWINGS

FIG. 1 is a diagram illustrating an exemplary configuration of a search system including a TV in accordance with an embodiment of the present invention.

FIG. 2 is a diagram illustrating an example of a screen display on a TV.

FIG. 3 is a diagram illustrating an example of a screen display on a TV during a search.

FIG. 4 is a diagram illustrating an example of a search results screen display on a TV.

FIG. 5 is a block diagram illus rating an exemplary hardware configuration of a TV.

FIG. 6 is a diagram illustrating an example of recording audio data.

FIG. 7 is a diagram illustrating another example of recording audio data.

FIG. 8 is a diagram illustrating yet another example of recording audio data.

FIG. 9 is a block diagram illustrating an exemplary functional configuration of a controller.

FIG. 10 is a block diagram illustrating an exemplary configuration of a search server.

FIG. 11 is a diagram illustrating an example of matching by a search server.

FIG. 12 is a flowchart explaining a recording control process of a TV.

FIG. 13 is a flowchart explaining a search process of a TV.

FIG. 14 is a diagram explaining a search results screen display.

### DESCRIPTION OF EMBODIMENTS

### Search System Configuration

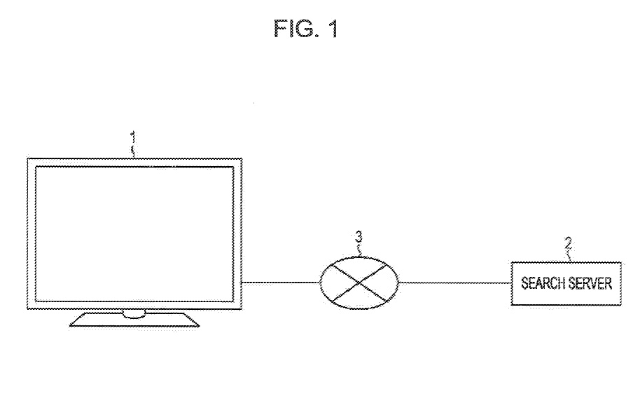

FIG. 1 is a diagram illustrating an exemplary configuration of a search system including a TV 1 in accordance with an embodiment of the present invention.

The search system in FIG. 1 consists of a TV 1 (i.e., an apparatus) and a search server 2 (i.e., an apparatus) coupled via a network 3 such as the Internet.

The TV 1 receives digital terrestrial broadcasts, BS (Broadcasting Satellite)/CS (Communications Satellite) digital broadcasts, etc., and plays back television program data to display a television program picture while also outputting television program audio from one or more speakers. Also, the TV 1 plays back data stored on a BD (Blu-ray (trademarked) Disc) or other recording medium, such as movie data, for example, to display a movie picture while also outputting movie audio from one or more speakers.

Hereinafter, the case of playing back and outputting a broadcast television program will be primarily described, but the TV 1 has functions for playing back various content consisting of video data and audio data in this way.

Also, the TV 1 includes functions such that, in the case of being ordered by a user viewing a television program to search for song information, i.e. information regarding a song being played at that time, the TV 1 accesses the search server 2 to conduct a search and displays information such as the song title and the artist name. Songs are sometimes included as BGM in the audio of television programs themselves and in the audio of commercials inserted between the television programs themselves.

FIG. 2 is a diagram illustrating an example of a screen display on the TV 1 during television program playback.

Operation will be described for when orders are given by the user to search for song information in the case where a television program picture is being displayed while audio is also being output, as illustrated in FIG. 2. The musical notes illustrated on the left side of FIG. 2 indicate that a given song is playing as BGM of a television program. Orders to search for song information are issued using a remote control, for example.

The TV 1 includes a ring buffer of given capacity, and constantly records the audio data of a television program while the television program is viewed. The TV 1, in the case of being ordered to search for song information, conducts an analysis of audio data recorded in the ring buffer, and generates feature data for the song that was playing when the search was ordered.

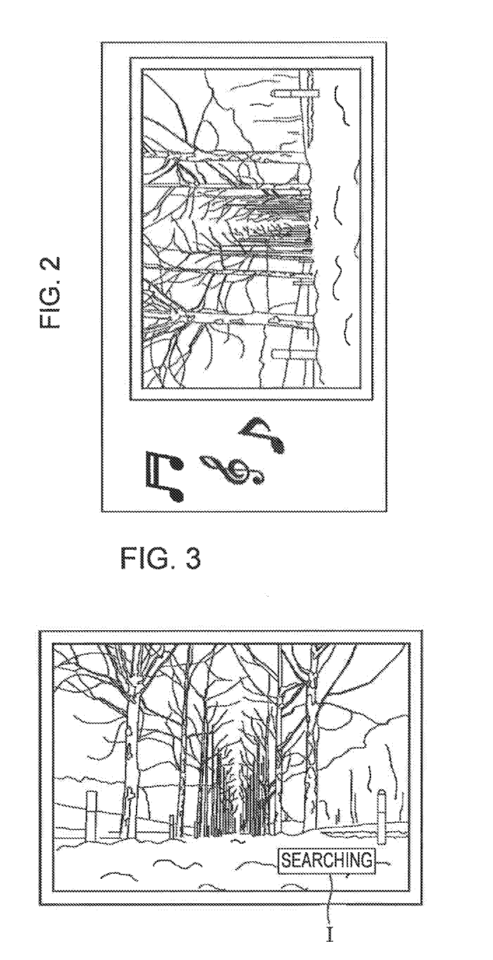

The TV 1 transmits generated feature data to the search server 2 and requests a search for song information on a song that was playing when the search was ordered. After requesting a search, an icon I indicating there is a search for song information in progress is displayed on the TV 1, overlaid with a television program picture as illustrated in FIG. 3.

For each of a plurality of songs, the search server 2 manages song information such as the song title, artist name, album name that includes the song, etc. in association with song feature data. The search server 2 receives feature data transmitted from the TV 1 together with a search request, and specifies a search result song by matching the feature data transmitted from the TV 1 with the feature data of respective songs already being managed. The search server 2 transmits song information on the specified song to the TV 1.

The TV 1 receives song information transmitted from the search server 2, and displays the content of the received song information as search results.

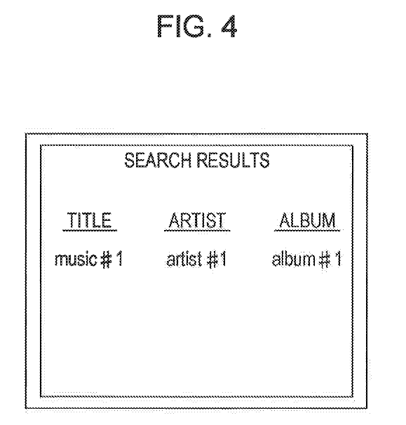

FIG. 4 is a diagram illustrating an example of a search results screen display.

In the example in FIG. 4, a song title “music#1”, an artist name “artist#1”, and an album name “album#1” are displayed as song information on a song that was playing when a search was ordered by the user.

Thus, by ordering a search in the case where a song of interest was playing while viewing a television program, the user is able to check information on the song of interest. Also, since constant recording of the audio data of television programs is conducted, a search can be conducted on the basis of audio data being recorded, even in cases where finding the remote control takes time and effort and a search is ordered after some time has passed since the song started.

Since the recording medium (i.e., the memory) used to constantly record audio data is a ring buffer, it is not necessary to prepare a recording medium with a recording capacity that is larger than is necessary. Recording audio data to a ring buffer will be discussed later.

### Configuration of Respective Apparatus

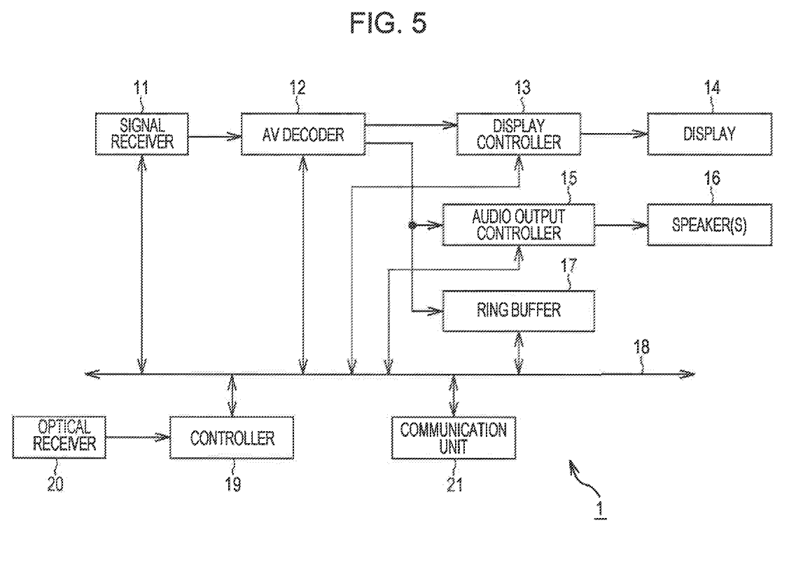

FIG. 5 is a block diagram illustrating an exemplary hardware configuration of a TV 1.

A signal receiver 11 receives a signal from an antenna not illustrated, performs A/D conversion processing, demodulation processing, etc., and outputs television program data (i.e., content data) obtained thereby to an AV decoder 12. Video data and audio data is included in the television program data. In the case where content recorded onto a recording medium such as a BD is played back on the TV 1, data of content read out from the recording medium is input into the AV decoder 12.

The AV decoder 12 decodes video data included in television program data supplied from the signal receiver 11, and outputs data obtained by decoding to a display controller 13. In the AV decoder 12, decompression of compressed data and playback of uncompressed data is conducted, for example.

The AV decoder 12 also decodes audio data included in television program data supplied from the signal receiver 11 and outputs data obtained by decoding. Uncompressed audio data output from the AV decoder 12 is supplied to an audio output controller 15 and a ring buffer 17.

The display controller 13, on the basis of video data supplied from the AV decoder 12, causes a television program picture to be displayed on a display 14 consisting of an LCD (Liquid Crystal Display), etc.

The audio output controller 15 causes television program audio to be output from one or more speakers 16 on the basis of audio data supplied from the AV decoder 12. Songs (music) are included in television program audio as BGM, where appropriate.

The ring buffer 17 records audio data supplied from the AV decoder 12. Audio data recorded to the ring buffer 17 is read out by a controller 19 via a bus 18 as appropriate.

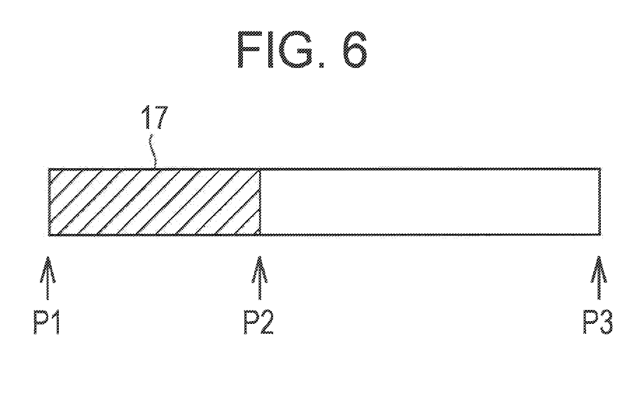

FIG. 6 is a diagram illustrating an example of recording audio data to the ring buffer 17.

The band illustrated in FIG. 6 represents the entire recording area of the ring buffer 17. The capacity of the recording area of the ring buffer 17 is taken to be a capacity enabling recording of just a few seconds of L channel data and R channel data, respectively, in the case where television program audio data is stereo data, for example.

Audio data supplied from the AV decoder 12 is sequentially recorded starting from a position P1, i.e., the lead position of the recording area. The audio data is recorded in the order it is output from the one or more speakers 16, with the L channel data and the R channel data alternating in data units of a given amount of time, such as several ms. In the example in FIG. 6, recording starts from the position P1, and the area up to a position P2 indicated with diagonal lines is taken to be an already-recorded area.

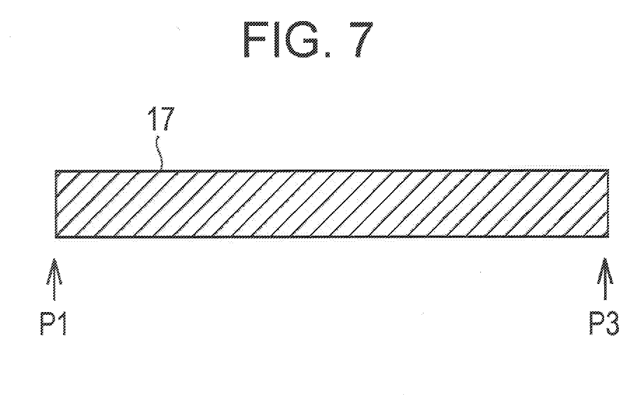

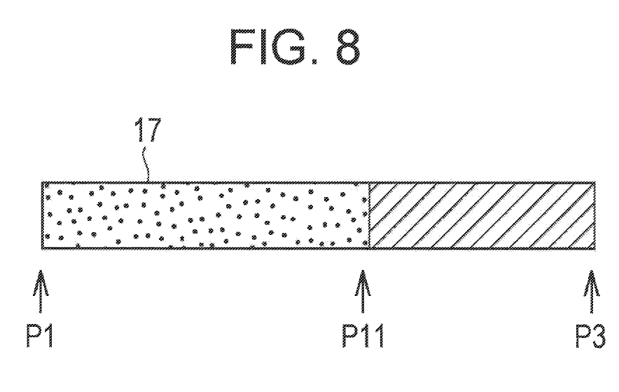

When the position of the already-recorded area advances to a position P3 and the free area runs out as illustrated in FIG. 7, audio data supplied from the AV decoder 12 is recorded to the ring buffer 17 so as to sequentially overwrite previously recorded data, as illustrated in FIG. 8. In FIG. 8, the area from the position P1 to a position P11 indicated with dots represents the recording area of audio data recorded so as to overwrite already-recorded data.

In this way, while a television program is being played back in the TV 1, constant recording of the audio data of the television program being played back is conducted using the ring buffer 17.

Returning to the explanation of FIG. 5, a controller 19 controls overall operation of the TV 1 via a bus 18 in accordance with information supplied from an optical receiver 20. For example, in the case of being ordered by the user to search for song information during playback of a television program, the controller 19 controls the recording of audio data to the ring buffer 17 while also reading out audio data from the ring buffer 17 and conducting a search for song information.

The optical receiver 20 receives signals transmitted from a remote control, and outputs information expressing the content of user operations to the controller 19.

A communication unit (i.e., a software module, a hardware module, or a combination of a software module and a hardware module) 21 communicates with the search server 2 via a network 3, and transmits feature data to the search server 2 in accordance with control by the controller 19. The communication unit 21 also receives song information transmitted from the search server 2, and outputs it to the controller 19.

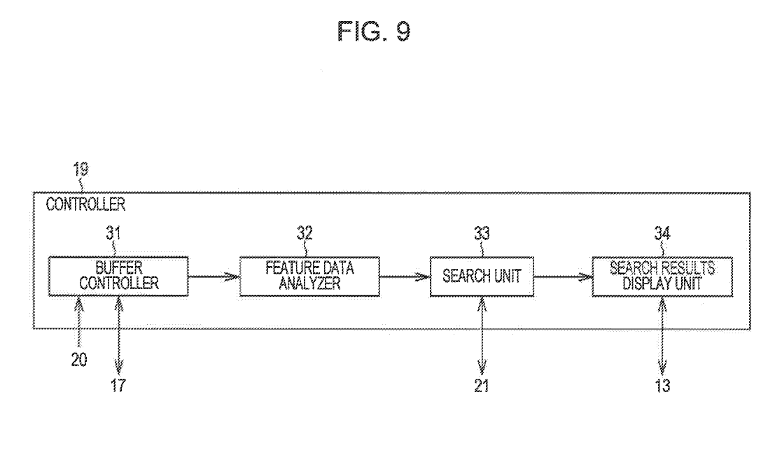

FIG. 9 is a block diagram illustrating an exemplary functional configuration of a controller 19.

At least some of the function units illustrated in FIG. 9 are realized due to a given program being executed by a CPU (Central Processing Unit) not illustrated that is included in the controller 19. The controller 19 consists of a buffer controller 31, a feature data analyzer 32, a search unit 33 (i.e., an interface unit), and a search results display unit 34. Information output from the optical receiver 20 is input into the buffer controller 31.

The buffer controller 31 controls the recording of audio data to the ring buffer 17. In the case where a search for song information is ordered by the user, the buffer controller 31 suspends the recording of audio data to the ring buffer 17 and reads out that audio data recorded at that time from the ring buffer 17.

For example, in the case where a search for song information (i.e., information regarding content) is ordered when audio data has been recorded up to the position P11 in FIG. 8, the buffer controller 31 does not cause recording overwriting the audio data in the area at and after the position P11, but reads out the audio data recorded at that time in the order it was recorded. In other words, the buffer controller 31 sequentially reads out the audio data recorded in the area from the position P11 to the position P3, and then sequentially reads out the audio data recorded in the area from the position P1 to the position P11.

The buffer controller 31 outputs audio data read out from the ring buffer 17 to the feature data analyzer 32. Several seconds' worth of audio data able to be recorded in the recording area of the ring buffer 17 is thus supplied to the feature data analyzer 32.

The feature data analyzer 32 analyzes audio data supplied from the buffer controller 31, and generates feature data. The analysis of audio data by the feature data analyzer 32 is conducted with the same algorithm as the analysis algorithm used when generating the feature data managed by the search server 2. The feature data analyzer 32 outputs feature data obtained by analyzing to the search unit 33.

The search unit 33 controls the communication unit 21 to transmit feature data supplied from the feature data analyzer 32 to the search server 2 and request a search for song information. The search unit 33 acquires song information transmitted from the search server 2 and received at the communication unit 21. The search unit 33 outputs acquired song information to the search results display unit 34.

The search results display unit 34 outputs song information supplied from the search unit 33 to the display controller 13, and causes a search results screen as explained with reference to FIG. 4 to be displayed.

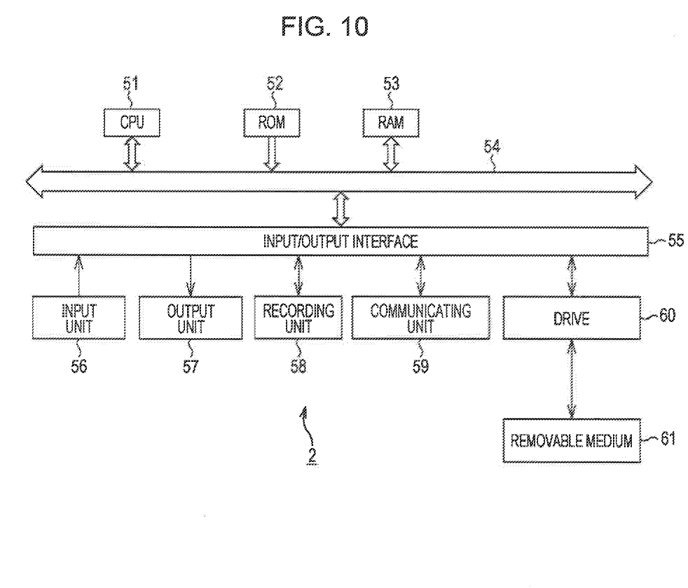

FIG. 10 is a block diagram illustrating an exemplary configuration of a search server 2.

As illustrated in FIG. 10, the search server 2 is realized by a computer. A CPU (Central Processing Unit) 51, ROM (Read Only Memory) 52, and RAM (Random Access Memory) 53 are mutually coupled by a bus 54.

Additionally, an input/output interface 55 is coupled to the bus 54. An input unit 56 consisting of a keyboard, mouse, etc., and an output unit 57 consisting of a display, one or more speakers, etc. are coupled to the input/output interface 55. Also coupled to the input/output interface 55 are a recording unit 58 consisting of a hard disk, non-volatile memory, etc., a communication unit 59 that communicates with a TV 1 via a network 3 and consists of a network interface, etc., and a drive 60 that drives a removable medium 61.

In the recording unit 58, for each of a plurality of songs, song information such as the song title, artist name, album name that includes the song, etc. is recorded in association with feature data generated by analyzing the audio data of respective songs.

When feature data transmitted from the TV 1 together with a search request is received at the communication unit 59, the CPU 51 acquires the received feature data as the feature data of a search result song. The CPU 51 matches the acquired feature data with feature data of respective songs recorded in the recording unit 58, and specifies the search result song. The CPU 51 reads out song information on the specified song from the recording unit 58, and transmits it from the communication unit 59 to the TV 1 as search results.

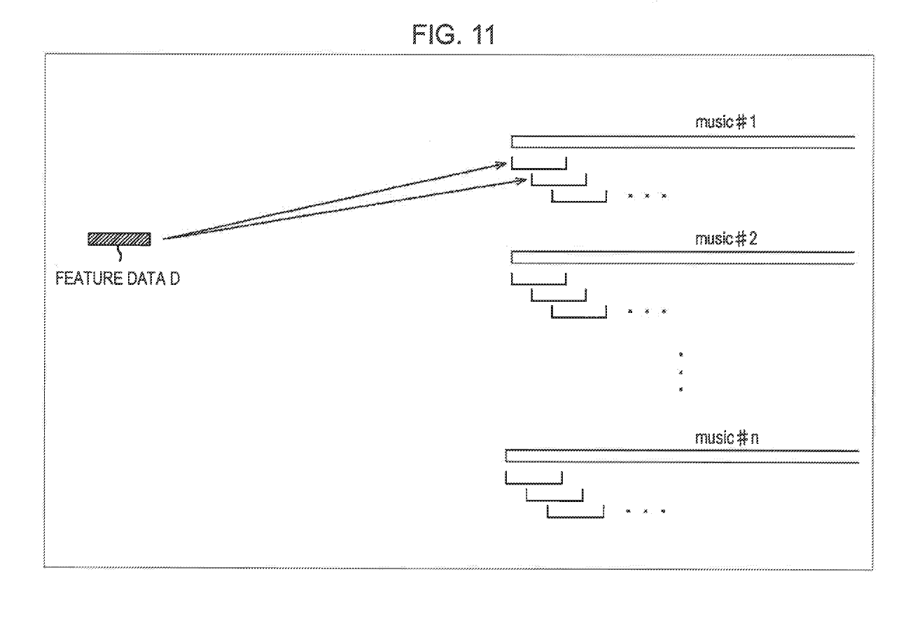

FIG. 11 is a diagram illustrating an example of matching by a search server 2.

The bands illustrated on the right side of FIG. 11 represent feature data generated on the basis of full audio data for respective songs. In the example in FIG. 11, feature data for music#1 to#n is illustrated. Meanwhile, the feature data D illustrated on the left side of FIG. 11 represents feature data transmitted from a TV 1.

Matching by the search server 2 is conducted by, for example, targeting the respective songs from music#1 to #n, and computing the degree of coincidence (i.e., the similarity) between the feature data D and feature data in individual segments of the full feature data for a target song. The segments for which the degree of coincidence with the feature data D is computed are segments expressing the features of an amount of audio data from the full target song equivalent to the amount of time recordable to the ring buffer 17 of a TV 1, and are set by sequentially shifting position.

The CPU 51 of the search server 2 specifies a song that includes a segment of feature data whose degree of coincidence with the feature data D is higher than a threshold value as the search result song, for example. The CPU 51 reads out song information on the specified song from the recording unit 58 and transmits it to the TV 1.

### Operation of TV 1

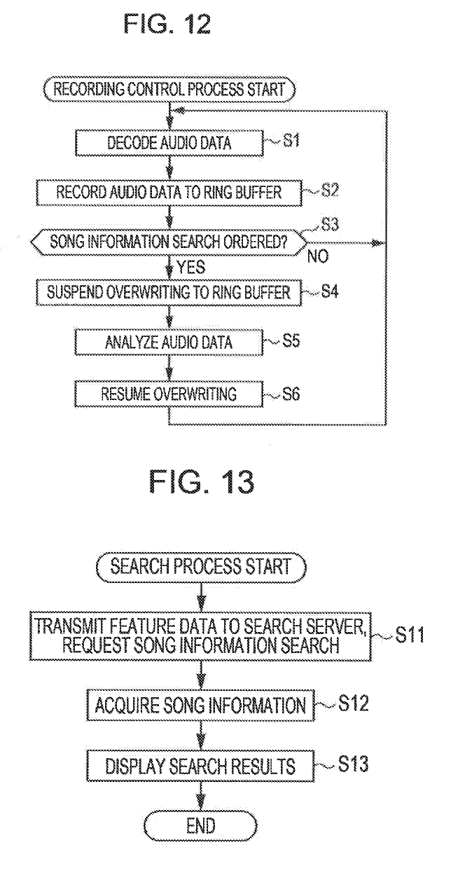

A process of the TV 1 that controls the recording of audio data to the ring buffer 17 will be explained with reference to the flowchart in FIG. 12. The process in FIG. 12, is repeatedly conducted while a television program is viewed, for example.

In a step S1, the AV decoder 12 decodes audio data included in television program data supplied from the signal receiver 11.

In a step S2, the buffer controller 31 causes decoded audio data to be recorded to the ring buffer 17 as explained with reference to FIGS. 6 to 8.

In a step S3, the buffer controller 31 determines whether or not a search for song information has been ordered by the user, on the basis of information supplied from the optical receiver 20. In the case where it is determined in step S3 that a search for song information has not been ordered by the user, the process returns to step S1, and the processing in step S1 and thereafter is conducted.

In contrast, in the case where it is determined in step S3 that a search for song information has been ordered by the user (i.e., that buffer controller 31 has received a command signal indicative of a search request), in a step S4, the buffer controller 31 causes the recording of audio data to the ring buffer 17 to be suspended. The buffer controller 31 reads out the audio data recorded at that time from the ring buffer 17.

In a step S5, the feature data analyzer 32 analyzes audio data read out by the buffer controller 31, and generates feature data.

In a step S6, the buffer controller 31 causes the recording of audio data to the ring buffer 17 to be resumed. After that, the processing in step S1 and thereafter is repeated.

For example, in the case where a search for song information is ordered by the user and the analysis of recorded audio data is conducted given the state in FIG. 8, the recording of audio data is resumed with the position P11 as the start position. Decoded audio data after resuming is recorded to the area from the position P11 to the position P3, and once again to the area at and after the position P1, so as to overwrite already-recorded audio data.

Next, a process of a TV 1 that conducts a search for song information will be explained with reference to the flowchart in FIG. 13. The process in FIG. 13 is conducted each time audio data is analyzed in step S5 of FIG. 12 and feature data is generated, for example.

In a step S11, the search unit 33 transmits feature data generated by the feature data analyzer 32 to the search server 2, and requests a search for song information. Matching as explained with reference to FIG. 11 is conducted at the search server 2 that has received feature data from the TV 1. Song information on a search result song is transmitted from the search server 2 to the TV 1.

In a step S12, the search unit 33 acquires song information transmitted from the search server 2 and received at the communication unit 21.

In a step S13, the search results display unit 34 outputs song information acquired by the search unit 33 to the display controller 13 (i.e., generates a display signal), and causes a search results screen explained with reference to FIG. 4, which includes information regarding a song, to be displayed.

According to the above processes, in the case where a song of interest is played while a television program is viewed, the user is able to check information on the song of interest merely by operating a remote control to order a search.

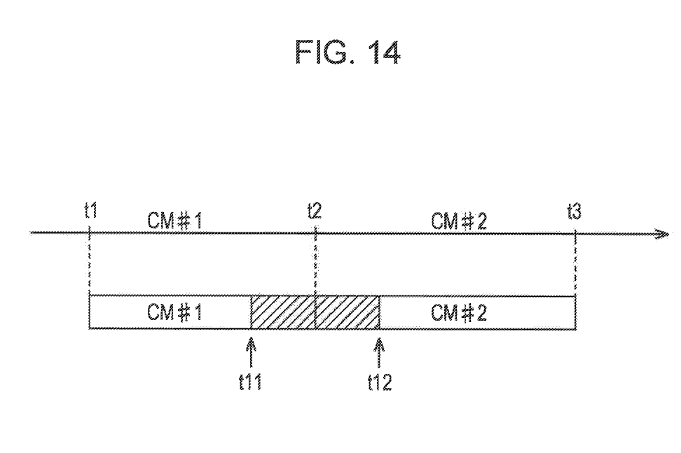

FIG. 14 is a diagram explaining the display of a search results screen in the case where feature data generated by the feature data analyzer 32 expresses the features of a plurality of songs.

In the case where the timing when the user orders a search is a timing immediately after the song switches from one song to the next song, feature data generated by the feature data analyzer 32 will become data expressing features of two songs: the song that was playing earlier, and the song that was playing next. In this case, a plurality of songs are specified as search result songs at the search server 2, and song information on the respective songs is transmitted to the TV 1.

For example, consider the case where a commercial CM#1 is broadcast (a picture of a commercial CM#1 is displayed while audio of a commercial CM#1 is output) from a time t1 to a time t2, and a commercial CM#2 is broadcast from a time t2 to a time t3, as illustrated in FIG. 14. Assume that given songs are played as BGM for both commercials CM#1 and CM#2.

In this case, when a search for song information is ordered at a time t12 immediately after the commercial CM#2 begins broadcasting, audio data for the commercial CM#1 from the time t11 to the time t2 and audio data for the commercial CM#2 from the time t2 to the time t12 is recorded to the ring buffer 17. At the feature data analyzer 32, on the basis of the audio data recorded to the ring buffer 17, feature data consisting of data expressing features of audio data for a partial segment of the commercial CM#1 and data expressing features of audio data for a partial segment of the commercial CM#2 is generated.

At the search server 2, matching between the feature data generated by the feature data analyzer 32 and the feature data of respective songs is conducted, and the song for the commercial CM#1 and the song for the commercial CM#2 are specified as search result songs. Song information on the song for the commercial CM#1 and song information on the song for the commercial CM#2 is transmitted from the search server 2 to the TV 1 and acquired by the search unit 33.

Since the user ordered a search for song information when the song for the commercial CM#2 was playing, from among the song information on the song for the commercial CM#1 and the song information on the song for the commercial CM#2 acquired by the search unit 33, the search results display unit 34 causes the song information on the song for the commercial CM#2 to be displayed before the song information on the song for the commercial CM#1 in the display order. In the case where search results are displayed arranged in a vertical direction, the song information on the song for the commercial CM#2 is displayed above the song information on the song for the commercial CM#1, for example. In the case where search results are displayed arranged in a horizontal direction, the song information on the song for the commercial CM#2 is displayed to the left of the song information on the song for die commercial CM#1, for example.

Since the song that was playing when the user ordered a search for song information was the song for the commercial CM#2, the song for the commercial CM#2 is specified by the search server 2. This is based on the fact that the song for the commercial CM#2 includes a segment of feature data that matches the latter half of the data from among the full feature data generated by the feature data analyzer 32, for example. The latter half of the data from among the full feature data generated by the feature data analyzer 32 is data expressing features of a time period including the time at which the user ordered a search for song information.

In the case where a plurality of songs are specified as search result songs, song information is transmitted from the search server 2 to the TV 1, together with information expressing which song is the song that was playing in a time period including the time at which the user ordered a search for song information, for example. The search results display unit 34, on the basis of information transmitted from the search server 2, causes the song information on the song for the commercial CM#2, i.e. the song that was playing in a time period including the time at which the user ordered a search for song information, to be displayed before the song information on the song for the commercial CM#1.

Herein, it may also be configured such that the user is able to rearrange the display order of song information displayed on a search results screen.

It may also be configured such that, for each song specified as a search result song, information expressing the degree of coincidence with the feature data generated by the feature data analyzer 32 is transmitted from the search server 2 to the TV 1, with the song information being displayed arranged in order of songs that include segments of feature data with a high degree of coincidence.

### Modifications

In the foregoing, a search for song information was taken to be conducted by a search server 2, but it may also be configured to be conducted by a TV 1. In this case, song information is recorded in association with feature data generated by analyzing the audio data of respective songs in a recording unit, not illustrated, of the TV 1. When a starch for song information is ordered, the TV 1 generates feature data as discussed above, and conducts a search for song information by matching the generated feature data with feature data recorded in the recording unit (i.e., the memory) included in the TV 1 itself.

Also, in the foregoing, the generation of feature data based on audio data recorded to a ring buffer 17 was taken to be conducted by a TV 1, but it may also be configured to be conducted by a search server 2. In the case where a search for song information is ordered, the TV 1 transmits audio data recorded in the ring buffer 17 to the search server 2 and requests a search for song information.

The search server 2 analyzes audio data transmitted from the TV 1 similarly to the processing conducted by the feature data analyzer 32, and conducts a search for song information as discussed earlier on the basis of generated feature data. The search server 2 specifies a search result song and transmits song information on the specified song to the TV 1. The TV 1 displays the content of song information transmitted from the search server 2.

Furthermore, in the foregoing, the recording of audio data to the ring buffer 17 was taken to be suspended when a search for song information is ordered by the user. However, it may also be configured such that the recording of audio data to the ring buffer 17 is suspended after a given amount of time has passed, using the time at which a search for song information was ordered by the user as a reference.

The foregoing describes a case of searching for song information on a song playing while content consisting of video data and audio data is played back. However, the processing discussed above is also applicable to the case of searching for song information on a song playing on the radio or a song playing while a Web page is viewed.

### Regarding a Program

The series of processes discussed above can be executed by hardware, but also can be executed by software. In the case of executing the series of process by software, a program constituting such software is installed onto a computer built into special-purpose hardware, or alternatively, onto a general-purpose personal computer, etc.

The program to be installed is provided recorded onto the removable medium 61 (i.e., the non-transitory, computer-readable storage medium) illustrated in FIG. 10, which consists of an optical disc (CD-ROM (Compact Disc-Read Only Memory), DVD (Digital Versatile Disc), etc.) or semiconductor memory, etc. It may also be configured such that the program is provided via a wired or wireless transmission medium such as a local area network, the Internet, or a digital broadcast.

Herein, a program executed by a computer may be a program whose processes is conducted in a time series following the order explained in the present specification, but may also be a program whose processes are conducted in parallel or at required timings, such as when a call is conducted.

An embodiment of the present invention is not limited to the embodiments discussed above, and various modification are possible within a scope that does not depart from the principal matter of the present invention.

### REFERENCE SIGNS LIST

1 TV

2 search server

19 controller

31 buffer controller

32 feature data analyzer

33 search unit

34 search results display unit

1. An apparatus for processing content data, comprising:
a memory;
a buffer controller configured to:
overwrite recorded content data stored in the memory with new content data;
receive a command signal indicative of a search request; and
in response to the command signal, stop the overwriting; and
a result display unit configured to generate a display signal to cause display of information regarding content represented by at least a portion of the recorded content data.

2. The apparatus of claim 1, wherein the at least a portion of the recorded content data is all of the recorded content data.

3. The apparatus of claim 1, wherein the buffer controller is configured to sequentially overwrite the recorded content data stored in the memory with the new content data in an order in which the new content data is sequentially received.

4. The apparatus of claim 1, comprising a data analyzer configured to generate first feature data based on the recorded content data.

5. The apparatus of claim 4, wherein the buffer controller is configured to, after the data analyzer generates the first feature data, resume the overwriting.

6. The apparatus of claim 4, wherein:
the memory is a first memory; and
the apparatus comprises:
a second memory configured to store second feature data and information regarding content represented by the second feature data; and
a search unit configured to determine the information regarding content represented by the at least a portion of the recorded content data based on a similarity between the generated first feature data and the second feature data stored in the second memory.

7. The apparatus of claim 4, wherein:
the memory is configured to store second feature data and information regarding content represented by the second feature data; and
the apparatus comprises a search unit configured to determine the information regarding content represented by the at least a portion of the recorded content data based on a similarity between the generated first feature data and the second feature data stored in the memory.

8. The apparatus of claim 4, wherein:
the at least a portion is a first portion of the recorded content data;
the apparatus is configured to store second feature data and information regarding content represented by the second feature data; and
the apparatus comprises a search unit configured to:
determine the information regarding content represented by the first portion of the recorded content data based on a similarity between the generated first feature data and the second feature data stored by the apparatus; and
determine information regarding content represented by a second portion of the recorded content data based on a similarity between the generated first feature data and the second feature data stored by the apparatus.

9. The apparatus of claim 1, wherein:
the at least a portion is a first portion of the recorded content data; and
the result display unit is configured to generate a display signal to cause display of information regarding content represented by a second portion of the recorded content data.

10. The apparatus of claim 9, wherein the result display unit is configured to generate a display signal to cause simultaneous display of:
the information regarding content represented by the first portion of the recorded content data; and
the information regarding content represented by the second portion of the recorded content data.

11. The apparatus of claim 9, wherein the result display unit is configured to generate a display signal to cause sequential display of:
the information regarding content represented by the first portion of the recorded content data; and
the information regarding content represented by the second portion of the recorded content data.

12. The apparatus of claim 1, comprising:
a communication unit configured to communicate with a server via a network; and
an interface unit configured to:
control the communication unit to receive the information from the server; and
output the information to the result display unit.

13. The apparatus of claim 12, wherein the interface unit is configured to control the communication unit to transmit the recorded content data to the server.

14. The apparatus of claim 12, wherein the interface unit is configured to control the communication unit to transmit the first feature data to the server.

15. The apparatus of claim 1, wherein the memory includes a ring buffer.

16. The apparatus of claim 1, wherein the recorded content data includes audio data.

17. The apparatus of claim 1, wherein the buffer controller is configured to, in response to the command signal, wait a predetermined period of time, and then stop the overwriting.

18. The apparatus of claim 1, wherein the information includes at least one of a name of a song or an artist of a song.

19. A method of processing content data, comprising:
overwriting recorded content data stored in a memory with new content data;
receiving a command signal indicative of a search request; and
in response to the command signal:
stopping the overwriting; and
generating a display signal to cause display of information regarding content represented by at least a portion of the recorded content data.

20. A non-transitory, computer-readable storage medium storing a program that, when executed by a processor, causes an apparatus to perform a method of processing content data, the method comprising:
overwriting recorded content data stored in a memory of the apparatus with new content data;
receiving a command signal indicative of a search request; and
in response to the command signal:
stopping the overwriting; and
generating a display signal to cause display of information regarding content represented by at least a portion of the recorded content data.
